(19) United States
(12) Patent Application Publication
(10) Pub. No.: US 2019/0309406 A1
(43) Pub. Date: Oct. 10, 2019

(54) THERMAL SPRAY ENHANCED BONDING USING EXOTHERMIC REACTION

(71) Applicant: ResOps, LLC, Tomball, TX (US)

(72) Inventors: Joe L. Scott, Tomball, TX (US); Hai Nguyen, Spring, TX (US)

(73) Assignee: ResOps, LLC, Tomball, TX (US)

(21) Appl. No.: 16/351,155

(22) Filed: Mar. 12, 2019

Related U.S. Application Data
(60) Provisional application No. 62/655,060, filed on Apr. 9, 2018.

(51) Int. Cl. C23C 4/131; C23C 4/11; C23C 4/067

(52) U.S. Cl. CPC C23C 4/131; B23K 35/0266; C23C 4/067; C23C 4/11

(57) ABSTRACT

The present disclosure provides a thermal spray system and method that utilizes an exothermic reaction. The exothermic reaction creates substantial heat and provides increased diffusion and bonding between different components of the wire alloy during coating and solidifying. The disclosed exothermic reaction creates greater diffusion of boron and carbon within the coating, increases bond strength between different components and/or solidified droplets or splats of the coating, and increases bonding strength between the coating and the substrate. The resulting coating provides greater homogeneity of the coating chemistry and fewer micro-cracks. The exothermic reaction may be created by a particular alloy composition (such as powdered elements within a cored wire) that creates and maintains a higher droplet temperature. The exothermic reaction may be created by the use of an oxidizer and a fuel, such as iron oxide and aluminum, as well as other reactive elements causing an exothermic reaction.

This application claims priority to U.S. provisional patent application No. 62/655,060, filed on Apr. 9, 2018, the entire content of which is incorporated herein by reference.

### BACKGROUND OF THE INVENTION

### Field of the Invention

The invention relates to thermal spray coatings applied to equipment and other substrates, and more particularly to thermally sprayed layers using an exothermic reaction over a wide range of substrates, including downhole equipment in oil and gas wells.

### Description of the Related Art

Drilling wells for oil and gas recovery, as well as for other purposes, involve the use of drill pipes and other downhole equipment necessary for the exploration and production of oil and gas. Downhole equipment is exposed to severe abrasive wear conditions and corrosive environments. Thermal spray coatings have been used to help prevent (or mitigate) wear conditions for downhole components.

As is known in the art, the term “thermal spray” is a generic term for a group of processes in which metallic, ceramic, cermet, and some polymeric materials in the form of powder, wire, or rod are fed to a torch or gun with which they are heated to near or somewhat above their melting point. The resulting molten or nearly molten droplets of materials are projected against the surface to be coated. Upon impact, the droplets flow into thin lamellar particles adhering to the surface, overlapping and interlocking as they solidify. The total coating thickness is usually generated in multiple passes of the coating device; depending on the application, the layer may be applied in thick deposits exceeding 0.006,″ although ranges in the amount between 0.020″ up to 3.0″ are possible. Various thermal spray techniques may include flame spraying, flame spray and fuse, electric-arc (wire-arc) spray, and plasma spray. Thermal spray may be applied to a wide variety of tools, equipment, structures, and materials, and is not limited to merely downhole components. Thermal spray with special alloys is applied to drill pipe, casing, sucker rods and other components used in the drilling, completion and production of oil and natural gas. Among other benefits, this application is used to mitigate wear, reduce friction, and to create a standoff from the annulus of the hole.

The prior art discloses various methods for thermal spraying. For example, U.S. Pat. No. 7,487,840 (“the '840 patent”), incorporated herein by reference, discloses a protective wear coating on a downhole component for a well through a thermal spraying process in combination with an iron-based alloy. The thermal spraying process melts the material to be deposited while a pressurized air stream sprays the molten material onto the downhole component. The coating operation takes place at low temperatures without fusion or thermal deterioration to the base material. The wear resistance is increased while providing a lower coefficient of friction by the wear resistant layer relative to a coefficient of friction of the downhole equipment without the wear resistant layer. FIG. 3 of the '840 patent is reproduced in the present disclosure as FIG. 1A as an exemplary thermal spraying process that may be used in conjunction with the present invention. The following two paragraphs describe FIG. 3 of the '840 patent are reproduced from the specification of the '840 patent at column 6, 11. 3-27:
“FIG. 3 [FIG. 1A in the present disclosure] is a schematic diagram of an exemplary thermal spray system for applying a wear resistant layer to a downhole component, according to the present invention. One type of thermal spraying system 30 that is advantageously used is a twin wire system. The twin wire system uses a first wire 32 and a second wire 34. In at least one embodiment, the first wire 32 and the second wire 34 generally are of the same nature, whether solid or tubular, and the same diameter, but not necessarily of the same chemical composition. For example, the first wire 32 could be of a first composition, while the second wire 34 could of the same or a complementary composition to the first composition to yield a desired wear resistant layer on the base material.”
“A voltage is applied to the wires. The proximity of the wire ends creates an arc 35 between the ends and cause the wires to melt. A high-pressure compressed air source 36 atomizes molten metal 38 caused by the arcing into fine droplets 40 and propels them at high velocity toward the downhole component, such as conduit 10 or other components, to being deposited on the external surface 26. The twin wire spraying process can use commercially available equipment, such as torches, wire feeding systems and power sources. Other thermal spraying processes are available and the above is only exemplary as the present invention contemplates thermal spraying processes in general for this particular invention.”

Likewise, U.S. Pat. No. 9,920,412 (“the '412 patent”), incorporated herein by reference, discloses a similar thermal spray technique with a chromium free composition of thermally sprayed material. While conventional thermally sprayed layers (such as that disclosed in the '840 patent and the '412 patent) are useful in numerous instances, such compositions and techniques are not helpful for all environments.

For example, in certain applications (such as on drill pipe and tools that are subject to severe flexing, torque and impact) they fail because the sprayed metal is brittle and develops cracks that propagate in fatigue loading. In particular, a significant part of the coating applied to drill pipes using conventional thermally sprayed techniques (and alloys) has “spalled” off and/or otherwise broken into smaller pieces and generally experienced dis-bonding issues. Such spalling significantly reduces the benefits of the coated layer and in many instances makes the drill pipe unusable for the intended application. Thus, conventionally thermally sprayed layers have not been dependable for drill pipe and are subjected to breaking, cracking, deforming, etc. under various applications.

The importance of either boron diffusion and/or carbon diffusion for its hardening affects is recognized. For example, U.S. Pat. No. 4,011,107, incorporated herein by reference, teaches the importance of a higher temperature above 1350 F for greater diffusion depth of boron. Further, various reactions have been used in thermal spray compositions to produce higher heats for the reaction. For example, U.S. Pat. No. 7,449,068, incorporated herein by reference, employs an apparatus that uses direct oxidation of aluminum and other metals to generate heat and gas expansion. As another example, U.S. Patent Publication No. 2017/0211885, incorporated herein by reference, utilizes small mesh sizes for Si, Mg, and Ca particles for an exothermic reaction to achieve a quick heat generating reaction that improves bond strength.

A need exists for an improved method and system for thermally sprayed layers that are more resistant to cracking, breaking, and/or failure. A need exists for an improved method and system for thermally sprayed layers that are more resistant to micro-cracks. A need exists for an improved method and system for thermally sprayed layers that promotes boron and/or carbon diffusion.

### SUMMARY OF THE INVENTION

The present disclosure provides a thermal spray system and method that utilizes an exothermic reaction. The exothermic reaction creates substantial heat and provides increased diffusion and bonding between different components of the wire alloy during coating and solidifying. The disclosed exothermic reaction creates greater diffusion of boron and carbon within the coating, increases bond strength between different components and/or solidified droplets or splats of the coating, and increases bonding strength between the coating and the substrate. The resulting coating provides greater homogeneity of the coating chemistry and fewer micro-cracks. The exothermic reaction may be created by a particular alloy composition (such as powdered elements within a cored wire) that creates and maintains a higher droplet temperature. The exothermic reaction may be created by the use of an oxidizer and a fuel, such as iron oxide and aluminum, as well as other reactive elements causing an exothermic reaction. The object to be coated may be a downhole component or other tool used in the oil and gas industry, or may be applied to any object or tool that needs increased wear and/or crack and/or corrosion resistance.

In one embodiment, disclosed is a composition for thermally spraying to a substrate, wherein the composition comprises a plurality of reactants that create an exothermic reaction when ignited and thermally sprayed onto the substrate. The plurality of reactants may comprise powdered elements within a cored wire, such as aluminum and iron oxide, lithium and iron oxide, or magnesium and copper oxide. In general, the plurality of reactants must at least combine an oxide and a metal/active element to create the exothermic reaction. In one embodiment, an oxide may be selected from the group of an oxide of copper, nickel, chromium, boron, silicon, bismuth, manganese, iron, and lead, and an active element may be selected from the group of aluminum, magnesium, lithium, titanium, zinc, and silicon. Other elements and combinations are possible to create the desired exothermic reaction. The composition may further comprise boron and carbon.

In one embodiment, the composition utilizes aluminum and iron oxide as the reactive elements to create the exothermic reaction when the composition is thermally sprayed onto the substrate. In this embodiment, the amount of aluminum to iron oxide may be approximately 1 part aluminum to 3 parts iron oxide and the amount of aluminum and iron oxide to other materials within the composition is at least 5 to 1. The aluminum and iron oxide may exist as powdered elements within a cored wire.

In one embodiment, the exothermic reaction is effective to increase diffusion of boron and/or carbon within the substrate. In one embodiment, the exothermic reaction is effective to cause metallurgical bonding between a layer of sprayed metallic material and the substrate. In one embodiment, the exothermic reaction is effective to eliminate and/or reduce the amount of micro-cracks within a layer of sprayed metallic material on the substrate. The exothermic reaction may occur in droplets of metallic material as they are sprayed onto the substrate, in droplets of metallic material during travel to the substrate, or in droplets of metallic material after being coated on the substrate. In one embodiment, the exothermic reaction superheats droplets of metallic material during the thermal spray process.

Also disclosed is a cored wire for thermally spraying to a substrate, wherein the cored wire comprises an outer sheath substantially enclosing a plurality of powdered elements, wherein the plurality of powdered elements comprises a plurality of reactants that create an exothermic reaction when thermally sprayed onto the substrate. In one embodiment, the plurality of reactants comprises aluminum and iron oxide. In another embodiment, the plurality of reactants comprises an oxide selected from the group of an oxide of copper, nickel, chromium, boron, silicon, bismuth, manganese, iron, and lead, and an active element selected from the group of aluminum, magnesium, lithium, titanium, zinc, and silicon. A particle size for the plurality of reactants may be approximately 30 microns or greater, or in some embodiments less than 30 microns, such as between 10-20 microns. In one embodiment, the powdered elements may comprise born and carbon. In one embodiment, the outer sheath may be substantially solid, such as substantially steel or copper. substantially steel.

Also disclosed is a thermally sprayed coating on a substrate, which comprises a coating of metallic material on a substrate, which itself may be formed by a plurality of reactants that create an exothermic reaction when ignited and thermally sprayed onto the substrate. The plurality of reactants may comprise powdered elements within a cored wire, such as aluminum and iron oxide. In one embodiment, the coating comprises boron and carbon, and the substrate comprises boron and carbon diffused from the coating. In one embodiment, the coating is a wear-resistant layer and may be substantially free of micro-cracks. In other embodiments, the substrate comprises multiple layers or coatings, each of different compositions, such that the thermally sprayed metallic material is applied over a prior and/or first coating, which may or may not be a thermally sprayed layer.

Also disclosed is a method for applying a coating to a substrate, the method comprising thermally spraying metallic material on an external surface of a substrate and creating an exothermic reaction in the sprayed metallic material. The method may further comprise igniting a plurality of reactants (such as an oxidizer and fuel, such as aluminum and iron oxide) within a cored wire to create the exothermic reaction. In one embodiment, the thermal spray technique comprises a twin wire arc spray. In one embodiment, the substrate comprises a prior thermally sprayed coating, further comprising thermally spraying the metallic material on the prior coating.

The method may further comprise metallurgically bonding the sprayed metallic material with the substrate. The method may further comprise increasing a temperature of the metallic material on the substrate based on the exothermic reaction. The method may further comprise decreasing the cool down rate of the metallic material on the substrate based on the exothermic reaction. The method may further comprise diffusing boron and/or carbon into the substrate from the coating. The method may further comprise reducing the amount of micro-cracks within a layer of the sprayed metallic material on the substrate based on the exothermic reaction. The method may further comprise increasing the amount of boron or carbon diffusion into the substrate based on the exothermic reaction.

Also disclosed is a modified downhole component, comprising a downhole component with an external surface and a layer of metallic material that is thermally sprayed onto a portion of the external surface. In one embodiment, the layer is formed by a plurality of reactants that create an exothermic reaction when ignited and thermally sprayed onto the downhole component. In one embodiment, the exothermic reaction is created by an ignition of a plurality of reactants within a cored wire, such as iron oxide and aluminum. In one embodiment, the layer is resistant to the formation of micro-cracks when used downhole. In one embodiment, the component is a drill pipe or drill pipe tool joint, although many other downhole tools or components may be thermally sprayed with the disclosed wire composition.

In one embodiment, the substrate on which the thermally sprayed metallic material can be a wide range of tools, components, equipment, and devices. In one embodiment, the substrate may be a wide range of substrates, including metallic or non-metallic material. In one embodiment, the substrate is a downhole component, such as a drill pipe, downhole pump, or mud motor. In other embodiments, the substrate may be a marine device, such as a marine propeller.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A illustrates one prior art method of thermally spraying a downhole component, which is taken from FIG. 3 of U.S. Pat. No. 7,487,840.

FIG. 1B illustrates drill pipe with broken, cracked, and/or spalled thermally sprayed coatings.

FIG. 1C illustrates a cross-sectional view of a steel block test sample with a thermally sprayed coating according to prior art techniques/alloys, at a magnification of approximately of 1300×.

FIG. 2A illustrates a cross-sectional view of a cored wire according to one embodiment of the present disclosure.

FIG. 2B illustrates one embodiment of elemental diffusion for a thermally sprayed layer according to the present disclosure.

FIG. 3A illustrates a graph of the general coating process of different alloys (with and without aluminum and iron oxide) as a function of temperature over time.

FIG. 3B illustrates a graph of the cool down rate of different alloys (with and without aluminum and iron oxide) as a function of temperature over time after the alloys were applied to a substrate.

FIGS. 3C-3E are exemplary photographs of the tests relating to FIG. 3A and FIG. 3B.

FIG. 4A illustrates a cross-sectional view of a steel block test sample with a layer of the FAB coating (with aluminum and iron oxide) according to one embodiment of the present disclosure, at a magnification of approximately 1000×.

FIG. 4B illustrates the corresponding elemental composition of the applied coating from FIG. 4A at a magnification of approximately 300×.

FIG. 5A illustrates a cross-sectional view of a steel block test sample with a layer of the FB coating (conventional alloy without aluminum and iron oxide), at a magnification of approximately 1000×.

FIG. 5B illustrates the corresponding elemental composition of the applied coating from FIG. 5A at a magnification of approximately 300×.

FIGS. 6A-6C illustrate the corresponding elemental composition of an applied coating according to one embodiment of the present disclosure within the base metal of the substrate, at the interface between the coating and the substrate, and within a coating of the thermal spray on the substrate, respectively.

FIG. 7A illustrates a cross-sectional view of a thermally sprayed coating without using an exothermic reaction, at a magnification of approximately 69×.

FIG. 7B illustrates a cross-sectional view of a thermally sprayed coating (showing no cracks) using an exothermic reaction according to one embodiment of the present disclosure, at a magnification of approximately 69×.

FIG. 8 illustrates a cross-sectional view of a thermally sprayed coating (showing metallurgical bonding) using an exothermic reaction according to one embodiment of the present disclosure, at a magnification of approximately 7000×.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Overview

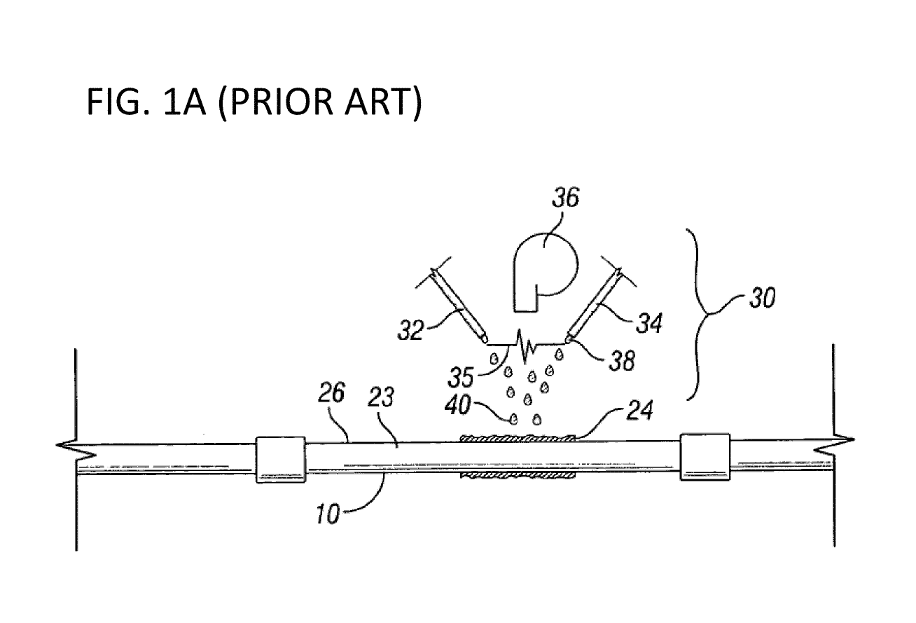

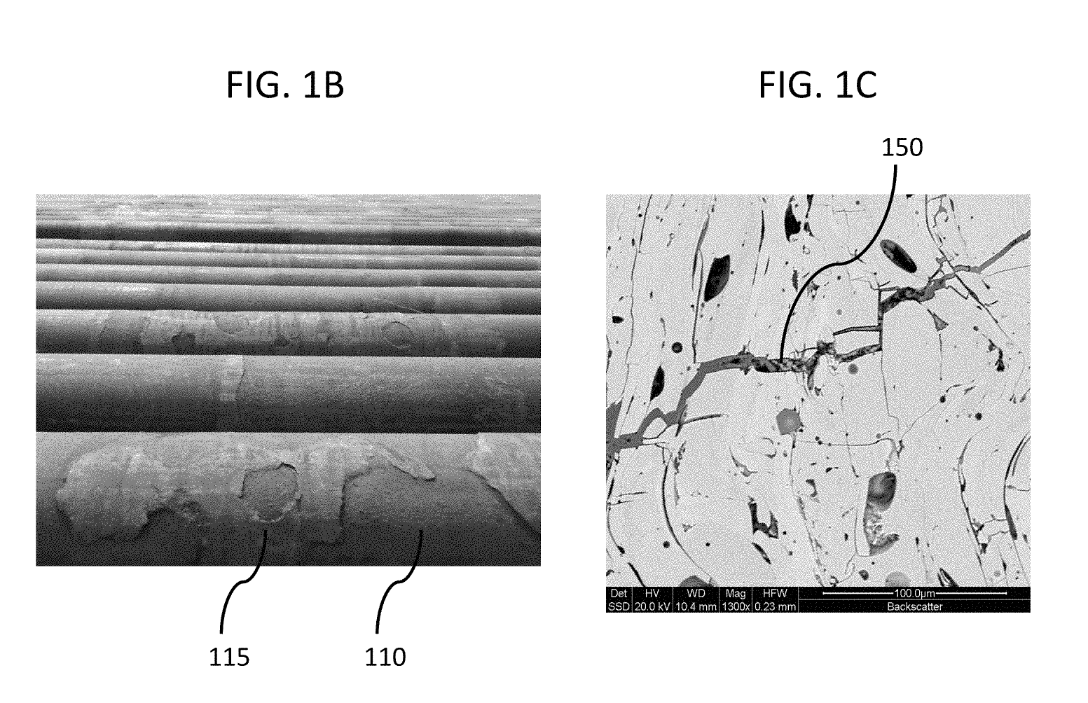

As mentioned above, in certain applications coatings applied via traditional thermally sprayed techniques and alloys fail in part because of cracks developed in the coating, which lead to spalling and other dis-bonding issues. For example, FIG. 1B illustrates drill pipe 110 with a coating that has experienced spalling 115. In part, these failures result from micro-cracks joining together as the drill pipe flexes. When a crack within the coating opens to the surface it is subject to environmental elements, such as chloride induced stress corrosion cracking. Further, these cracks tend to migrate to near the interface/bond line between the coating and the substrate and turn horizontally such that the micro-crack becomes planer letting in more chlorine until a patch dis-bonds and falls off. For example, FIG. 1C illustrates one view of micro-cracking 150 in a coating on a steel block test sample as a result of stress corrosion cracking test, seen at a magnification of approximately 1300×. The coating material in FIG. 1C is a conventional iron based alloy that is commercially used and sprayed by twin wire arc thermal spray techniques.

In general, conventional thermal spray coatings result in non-homogeneous coatings in part due to the low droplet temperatures, such as in cold spray or kinetic spray, and typically, thermal spray deposits have very high cooling rates. Often this negative trait is overcome in powder spray methods, such as High Velocity Oxy-Fuel (HVOF) and cold spray or kinetic metallization by using only pre-alloyed powders where all grains of powder are the same. However, when using cored wires, it is normal that the outer sheath of solid material is quite different than the powdered ingredients in the core. And these powdered ingredients are often a mechanical mixture of very different materials. Although the wires melt at arc temperatures, they are immediately detached and atomized by the steam of compressed air, or other gas such as nitrogen or oxy-fuel, and are rapidly propelled onto a substrate that is typically at ambient temperature causing instant transformation from the liquid or plastic state into a fully solidified form. Because the time for intermixing of the very different ingredients is extremely short, alloying and diffusion are inhibited.

In one embodiment, the present disclosure incorporates an exothermic reaction to a thermal spray technique to facilitate transfer of sprayed metallic material from a cored wire onto an exterior portion of a substrate, thereby forming a thermal spray coating on the substrate. In one embodiment, a thermal spray method and system may utilize an exothermic reaction in the thermal spray composition itself to create and maintain a higher droplet temperature. The use of an exothermic reaction minimizes and/or eliminates the presence of micro-cracks in the coating. The elimination and/or minimization of micro-cracks improves impact and fatigue strength of the coating and lessens the opportunity for corrosive failure of the coating. In one embodiment, the use of an exothermic reaction greatly improves bond strength of the coating, bond strength between the coating and the substrate, and bond strength between solidified droplets (splats) of the applied metallic material. In one embodiment, the use of an exothermic reaction improves bonding between powdered elements within a cored wire and the cored wire's outer sheathing (which is generally substantially solid). In one embodiment, the use of an exothermic reaction improves alloy homogeneity and diffusion of boron and/or carbon. In one embodiment, the use of an exothermic reaction results in metallurgical bonding between the thermally sprayed droplet and the base material.

In one embodiment, the exothermic reaction of the present disclosure utilizes iron oxide and aluminum. The reaction is chemically characterized by the following formula: Fe₂O₃+2Al→Al₂O₃+2Fe+heat. In one embodiment, the iron oxide (preferably Fe₂O₃) and aluminum (Al), in the correct mesh sizes, together decompose in the arc of a twin wire arc spray process and generate an exothermic reaction. Aluminum oxide (Al₂O₃) and iron (Fe) are the resultant forms, plus a significant amount of heat. This exothermic reaction super heats the droplets resulting in greater alloy mixing and melting/bonding time for the desired solidification structures to form. According to known methods using standard enthalpy values, the above exothermic reaction produces approximately −850 kJ/mol.

In one embodiment, for this reaction to initiate and continue both during the flight of the elements towards the substrate and even after colliding with the substrate, the mesh sizes of the iron oxide and aluminum particles should be small. A small particle size allows for a more even distribution in the powder core. In one embodiment, an effective mesh size for the aluminum and iron oxide particles is approximately 30 microns or more than 30 microns, but in other embodiments may be less than 30 microns or between 10-20 microns. In one embodiment, the aluminum particles (or other active elements) should not be heavily oxidized, as any amount of oxidation retards melting and availability for the reaction to rapidly take place.

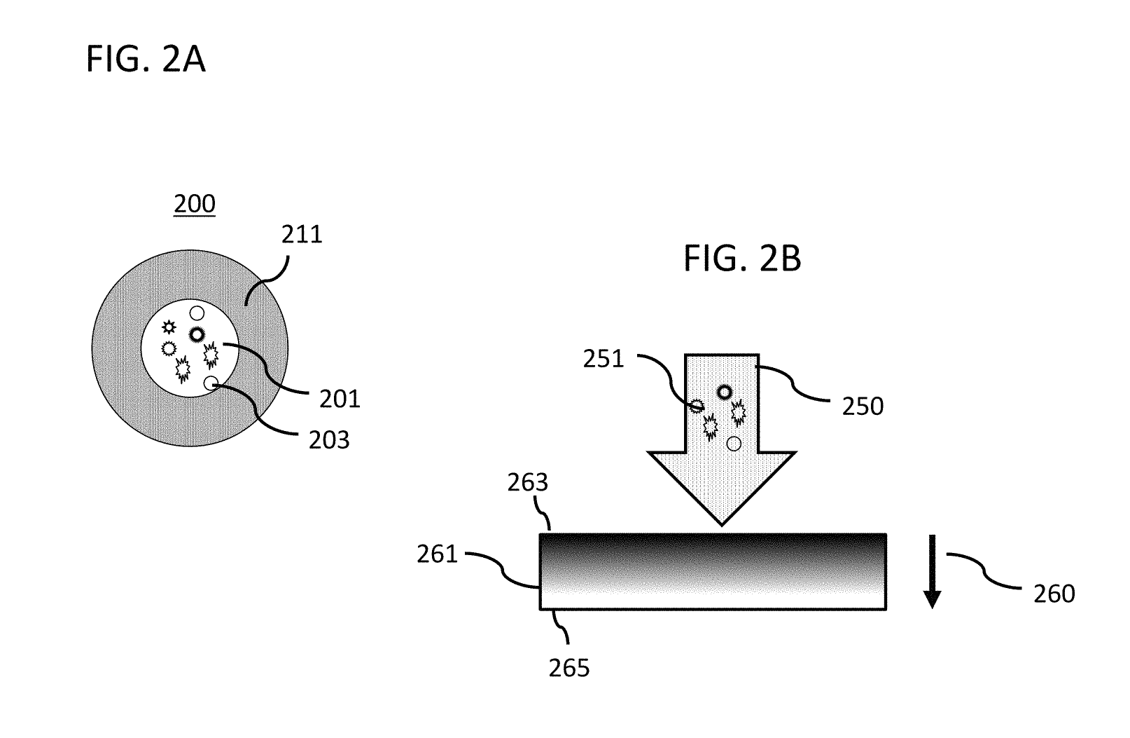

In one embodiment, the form of the spray material is a cored wire, in which the outer sheath may be a first mixture (and substantially solid) and an inner core material may have one or more powdered elements. The making of such outer sheaths and inner cores of the cored wire is known to those of skill in the art. FIG. 2A illustrates a cross-sectional of a cored wire according to one embodiment of the present disclosure. In one embodiment, cored wire 200 comprises outer sheath 211 and inner core 201. In one embodiment, the inner core may be approximately 30% weight of the overall wire and the outer solid metal wrapping may be approximately 70% weight of the overall wire. In one embodiment, the outer sheath may comprise substantially iron, steel, stainless steel, copper, nickel, cobalt, and/or aluminum. In another embodiment, the outer sheath may comprise substantially copper and nickel. In one embodiment, the inner core comprises the powdered ingredients of the alloy, and include powdered materials 203 such as borides, carbides, tin, iron oxide, aluminum, etc. In one embodiment, the powdered ingredients comprise aluminum and iron oxide. In one embodiment, the powdered ingredients comprise approximately 5-10% by weight of aluminum and 15-30% by weight of iron oxide. In one embodiment, the ratio of aluminum to iron oxide is 1:3. In one embodiment, the ratio of the iron oxide and aluminum to the other alloying materials in the wire is approximately 9:1.

In other embodiments, the exothermic reaction may also be accomplished by using other elements besides iron oxide and/or aluminum. In general, the droplets of the thermal spray coating may be superheated by the heat given off by any exothermic reaction of an oxidizer and a fuel, which produces heat and a byproduct (i.e., OXIDIZER+FUEL→PRODUCTS+HEAT). In one embodiment, the oxidizer (or oxidizing element) may be any number of oxides, such as oxides of iron, copper, nickel, bismuth, boron, silicon, chromium, manganese, or lead. In one embodiment, the fuel may be considered as an active element, and may consist of aluminum, magnesium, lithium, potassium, silicon, boron, titanium, or zinc. For the present disclosure, the oxidizing element and the active element may be considered as a plurality of reactants that form the exothermic reaction.

The plurality of reactants at room temperature are generally stable, but when ignited or otherwise energized, such as with an electric arc, they react spontaneously. The exothermic reaction generally occurs when the more active metal element reacts with and/or seizes the oxygen from the less active metal. Typically, the more active metal becomes an oxide and leaves the less active metal in its elemental state; the less active metal is then free to combine with other metals creating a new alloy or may be left in the elemental state. For example, aluminum forms stronger and more stable bonds with oxygen then iron, and thus aluminum may be considered as the fuel (e.g., the more active metal) and iron oxide is the oxygen source. The products of this reaction (aluminum and iron oxide) are aluminum oxide, elemental iron, and a large amount of heat. In other embodiments, various other oxidizing elements and/or active elements may be combined with and/or used in lieu of the iron oxide and aluminum reaction to create variable exothermic reactions and/or alloy compositions to achieve the desired result. As is known in the relevant art, metals and non-metals have different levels of activity or reactivity, as well as different enthalpies and energy production (or consumption). Such elemental activities and enthalpies of reactions are known and available in chemistry charts to one of skill in the art, and can be used in determining various mixtures and compositions of a thermal spray composition that can produce the desired exothermic reaction. In general, the exothermic reaction may be created by any particular alloy composition (such as powdered elements within a cored wire) that creates and maintains a higher droplet temperature. In one embodiment, an exothermic reaction is desired that produces a higher heat (e.g., hotter temperature) and a longer heat (e.g., duration of the hotter temperature).

In one embodiment, the use of an exothermic reaction substantially enhances the diffusion of boron and/or carbon within the sprayed coating and the applied substrate. While many thermal spray alloys use boron, typically boron is employed for its hardening effects in iron based alloys as opposed to mechanical properties via diffusion bonding. Literature indicates that, in general, boron and carbon diffusion can take place more rapidly and completely when the material is at a higher temperature. For example, it is known that the thickness of layers of carbon or boride increase as the temperature increases. However, enhanced diffusion of boron and carbon have been problematic because of the high temperatures (and/or durations of higher temperatures) necessary to promote diffusion of these elements, which are generally hard to accomplish via traditional thermal spray techniques and/or alloys.

Prior thermal spray techniques have been unsuccessful in diffusion of carbon and boron into the substrate, in part because the cooling rate of the coating and thermally sprayed material is too fast to allow diffusion. FIG. 2B schematically represents carbon and/or boron diffusion into a substrate according to one embodiment of the present disclosure. In general, the diffusion amount and depth are functions of time and temperature, where a higher temperature allows for a shorter time to achieve diffusion. For example, substrate 261 may have a surface with an outer portion 263 and an inner portion 265. Using thermal spray techniques, a layer of metallic material 250 with boron and/or carbon elements 251 (as well as other elements) may be deposited on exterior surface 263 of the substrate. After a certain amount of time (and based on various factors such as temperature, etc.), the boron and/or carbon elements will diffuse and/or penetrate into the substrate a given distance, resulting in a decreasing concentration of the diffused element with increased depth as illustrated by diffusion arrow 260. In general, according to one embodiment of the present disclosure, increased diffusion of carbon and/or boron enhances the overall strength and durability of the thermally sprayed coating.

In general, the disclosed alloy and exothermic reaction described herein improves bonding strength with boron and carbon and other components and enhances the amount of boron and carbon diffusion within the coating and between the coating and the substrate. The disclosed alloy and exothermic reaction creates substantial heat and provides increased diffusion and bonding between different components of the wire alloy during heating, coating, cooling, and solidifying. The disclosed alloy and exothermic reaction increases bond strength between different components and/or solidified droplets (splats) of the coating and increases bonding strength between the coating and the substrate. The resulting coating provides greater homogeneity of the coating chemistry. The resulting coating provides numerous benefits, including increased resistance to spalling, breaking, cracking, and deforming, crack formation, and added strength. Further, resistance to and the lack of micro-cracks in the coating prevents corrosion paths to grow, which generally lead to fatigue and spalling.

### Application

In one embodiment, the disclosed exothermic reaction and related thermal spray system and technique is applicable to any components or substrates that are subject to corrosion and wear damage. Further, while the method and system described herein is particularly suitable for cored wires and thermal spray techniques that use cored wires (such as twin wire arc spray), the disclosed embodiments are not necessarily limited to cored wires.

In one embodiment, the relevant components are downhole oil well production components such as electrically submersible pumps, sucker rods, and related components and other artificial lift equipment. However, the disclosed cored wire and exothermic reaction thermal spray system and technique is beneficial in other markets where severe corrosion is present and/or wear resistance is advantageous. While an embodiment of the disclosure is directed to drill pipe or other downhole components used in the oil and gas industry, a thermally sprayed layer of the disclosed alloy and exothermic reaction can be used in a variety of applications and industries. For example, it may be used for many other downhole components in the oil and gas industry, such as but not limited to drill pipes, drill pipe tool joints, heavy weight pipes, stabilizers, cross-overs, jars, MWDs, LWDs, drill bit shanks, etc. The disclosed alloy and exothermic reaction may also be used on objects other than downhole components where an increased wear and/or corrosion resistant layer is needed, such as dredge pups, cable sheaves, helicopter landing runners, etc., including the automotive, aviation, and marine industries. The disclosed wear and/or corrosion layer may also be used on banding to rigidly attach separate components, such as around drill pipe tool joints. In general, the disclosed wear and/or corrosion layer produced by an exothermic reaction may be used on any tool (and is not limited to downhole equipment) and with/on top of any alloy system. For example, a first layer of coating may be applied to a tool (such as an anti-corrosive thermally sprayed coating) and a second thermally sprayed layer (such as a coating utilizing an exothermic reaction as disclosed herein) may be applied to the first layer for its general improved wear resistance benefits.

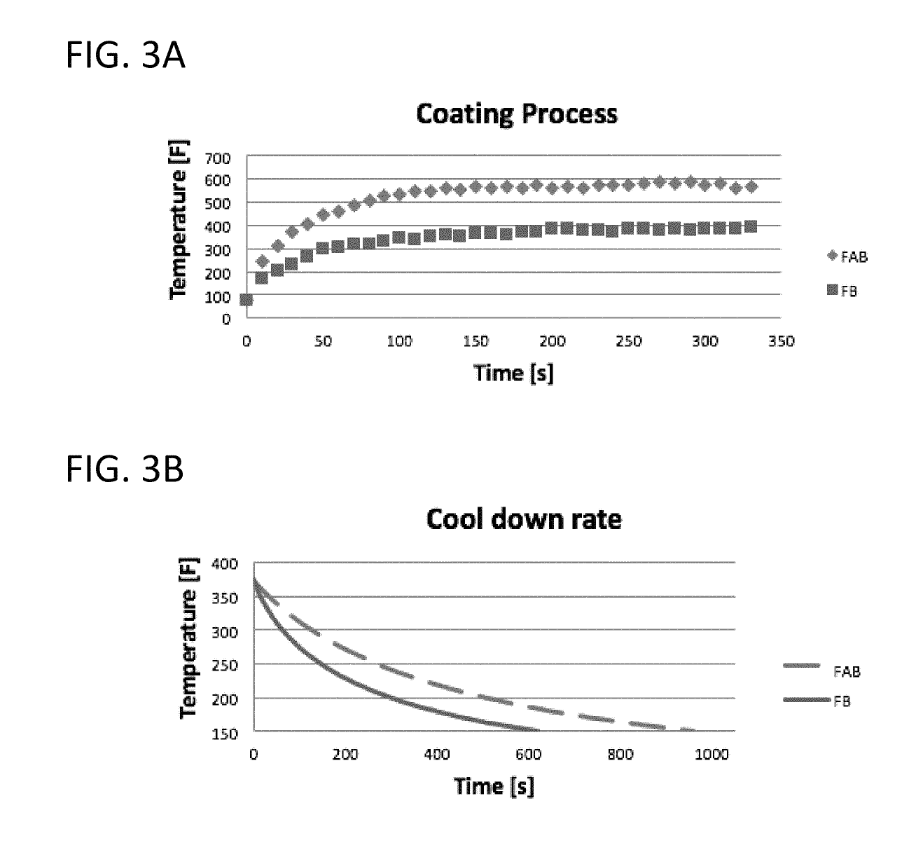

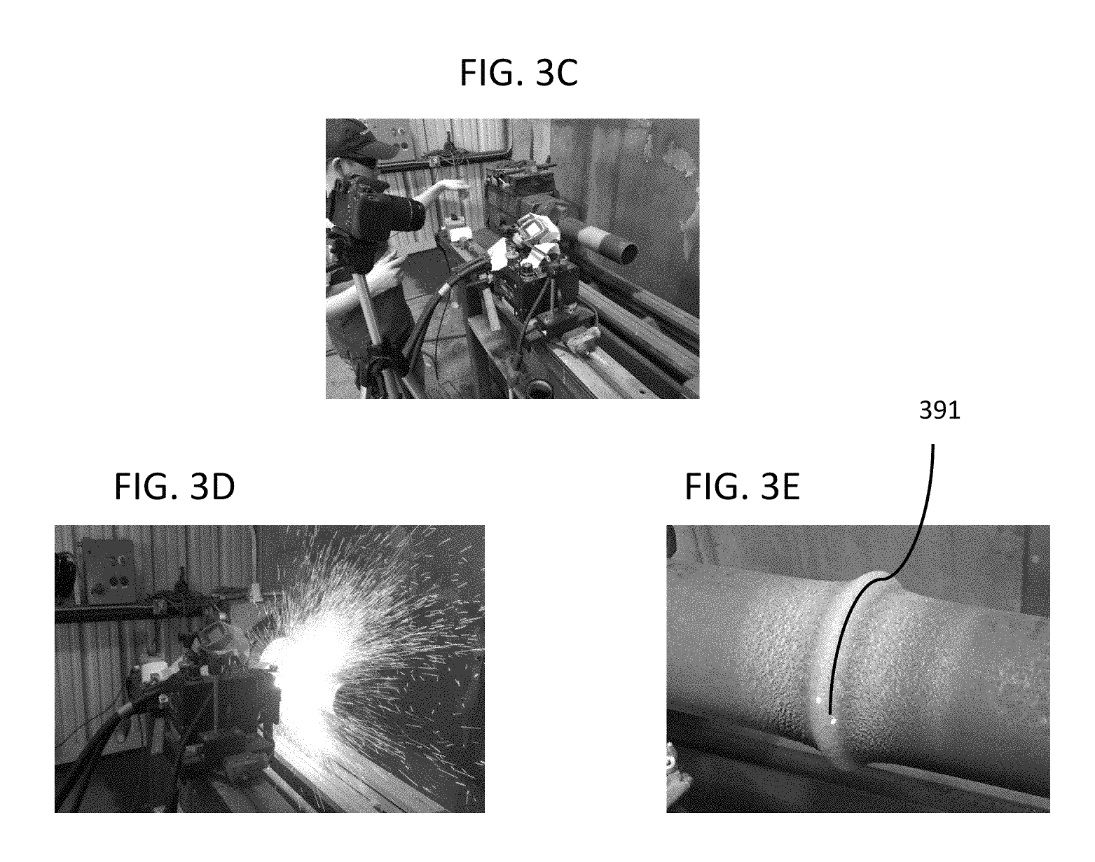

In general, a cored wire utilizing the disclosed components to produce an exothermic reaction can be readily made using known techniques. Further, a cored wire may be applied onto a substrate using well known thermal spray methods. The process of thermal spray is well known to those of skill in the art. Thermal spray is a flexible process and can be applied to a wide variety of substrates and/or surfaces, such as irregular, tubular, or flat surfaces and to virtually any metal or non-metal substrate. In general, the process involves cleaning the substrate and forming a rough surface profile on the substrate, which may be done by grit blasting, chemical etching, or mechanical means. Once profiled, the surface is coated with the disclosed alloy using any of a variety of thermal spray processes, such as High Velocity Oxy-Fuel (HVOF), Twin Wire Arc Spray (TWAS), Cold Spray, and Kinetic Metallization. Each of these different thermal spray processes is well known to those of skill in the art. In one embodiment, the utilized spray gun may be traversed along a cylindrical object where the object is rotating in a fixture such as a lathe or riding on pipe rollers (see, e.g., FIGS. 3C and 3D). Traversing of the spray gun may be done manually by a human operator, automatically by robot, or by affixing the gun to a traversing mechanism.

The disclosed coating may be applied to a room temperature substrate or the substrate may be pre-heated to approximately 200-400 degrees Fahrenheit. While typically the coating may be approximately 0.015″ thick, the disclosed coating can be applied both thinner and thicker as required. For example, the coating may be as small as 0.006″ or as large as 3″ thick. The tool being coated and the particular application of the tool will dictate the coating thickness. For many of the tests disclosed in the present application the substrate/tool was conventional 4″ drill pipe.

As discussed above, prior art coatings develop micro-cracks in the coating, some of which may extend to the surface of the coating. To address these cracks, conventional techniques typically paint or treat the coating surface with a low surface tension liquid to penetrate and seal the cracks. In one embodiment, the disclosed thermal spraying process does not require this subsequent treatment of the coating because it has no micro-cracks that open to the surface, so there is no path to absorb the low viscosity sealing liquids. In other words, the disclosed embodiment does not require a subsequent sealing step of the resultant thermally sprayed coating as is typical in conventional techniques.

### EXAMPLES AND TESTS

Various tests and different alloys demonstrate that the disclosed process and cored wire compositions producing an exothermic reaction reduces micro-cracks and improves bond strength in the resultant coating.

### Example 1

In general, the same alloy (via a cored wire) was applied to a substrate with and without the disclosed exothermic reaction for comparison purposes. In particular, two cored wires were made that included the same outer sheath material. Both of the inner powder materials of the cored wire samples were the same (including the same amounts of boron and carbon) except that sample FAB included aluminum and iron oxide powder materials, while Sample FB did not use these aluminum and iron oxide materials (and instead used conventional iron powder). Thus, sample FAB included certain powdered elements that would utilize an exothermic reaction while sample FB was a typical cored wire alloy that would not include an exothermic reaction. Both alloys included the same amount of boron and carbon (approximately 4 weight % of boron carbide). In this embodiment, the inner core is approximately 30 weight percent of the wire and the outer sheath (steel) is approximately 70 weight percent of the wire. The FAB alloy had approximately 6.5% weight aluminum and 19.5% weight iron oxide, while the FB alloy had approximately 26% weight of iron powder.

The substrate utilized for these tests was 4″ AISI 4137 alloy steel drill pipe. The thermal spray process was a twin-wire thermal spray process similar to that disclosed in U.S. Pat. No. 7,487,840. Standard procedures and parameters were used as is known in the art. Both wires were sprayed using the same parameters, which were 230 amps, 30.5 volts, 45 psi air pressure, and 6″ arc to work distance.

FIG. 3A shows a graph of the general coating process of the FAB alloy (the alloy with aluminum and iron oxide powder materials) and the standard FB alloy as a function of temperature over time. As illustrated in FIG. 3A, the FAB alloy was applied to the substrate at a much higher temperature than the FB alloy. For example, the FAB alloy reached a temperature of approximately 600 degrees Fahrenheit while the FB alloy only reached a temperature of about 400 degrees Fahrenheit. The difference in temperature points to the exothermic reaction created during the thermal spray process. In particular, the exothermic reaction is caused by the Al+Fe₂O₃ reaction discussed above. The higher temperatures caused by the exothermic reaction results in many benefits to the thermal spray coating as described herein.

FIG. 3B shows a graph of the cool down rate of the different FAB and FB alloys as a function of temperature over time after the alloys were applied to a substrate. In other words, FIG. 3B shows the temperature decay as a function of time. As illustrated in FIG. 3B, after being applied to the substrate, the FAB alloy cools at a much slower rate than the FB alloy. For example, the FB alloy and the FAB alloy reached a temperature of approximately 200 degrees Fahrenheit at approximately 300 seconds and 550 seconds, respectively. As another example, the FB alloy and the FAB alloy cooled to a temperature of approximately 150 degrees Fahrenheit at approximately 600 seconds and 900 seconds, respectively. The difference in cooling rates (and cooling temperatures) shows that the exothermic reaction created during the thermal spray process slowed the cooling rate for the coating. A slower cooling rate allows the coating to react and/or bond with the substrate at a higher temperature over a longer period of time, thereby strengthening the formed bonds and time for boron and carbon diffusion and metallurgical bonding.

The test set-up for the data relating to FIGS. 3A and 3B is shown in FIGS. 3C-3E, and is similar to conventional thermal spray techniques. The temperature was measured using a calibrated Fluke optical thermometer and the temperature read-out was recorded with a Nikon video camera which records time. As illustrated in FIG. 3E, the optical thermometer is directed towards the coating on the substrate, which allows a real-time measurement of the temperature of the coating during the thermal spray process (during and after coating). From this obtained data, the graph in FIGS. 3A and 3B were plotted. FIG. 3A shows the temperatures achieved on the deposit surface and demonstrates that the FAB alloy became 200 F hotter than the FB alloy. This measured temperature does not account for the droplet temperature at its formation or during flight from the gun to the substrate. Likewise, FIG. 3B shows the temperatures of the FAB alloy (causing the exothermic reaction) to have a slower cooling rate than the FB alloy (without an exothermic reaction). FIG. 3D illustrates a typical twin wire arc spray system in operation, and one used for the testing done related to FIGS. 3A and 3B. FIG. 3E illustrates the coating band as sprayed on a section of drill pipe and laser dot 391 (on the middle of the banding) represents exemplary points of temperature measurement.

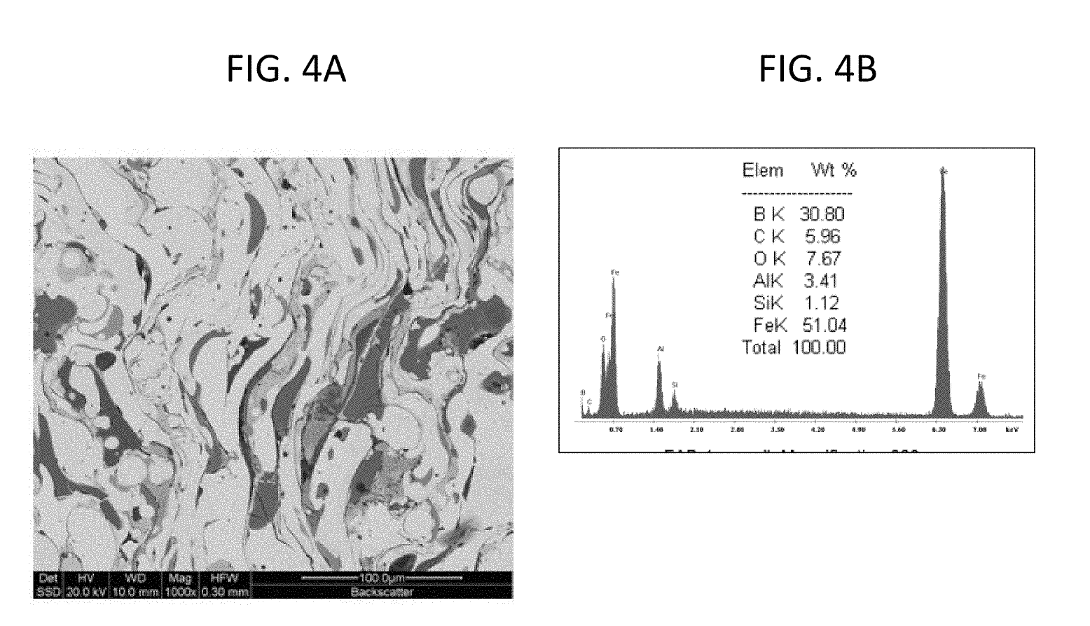

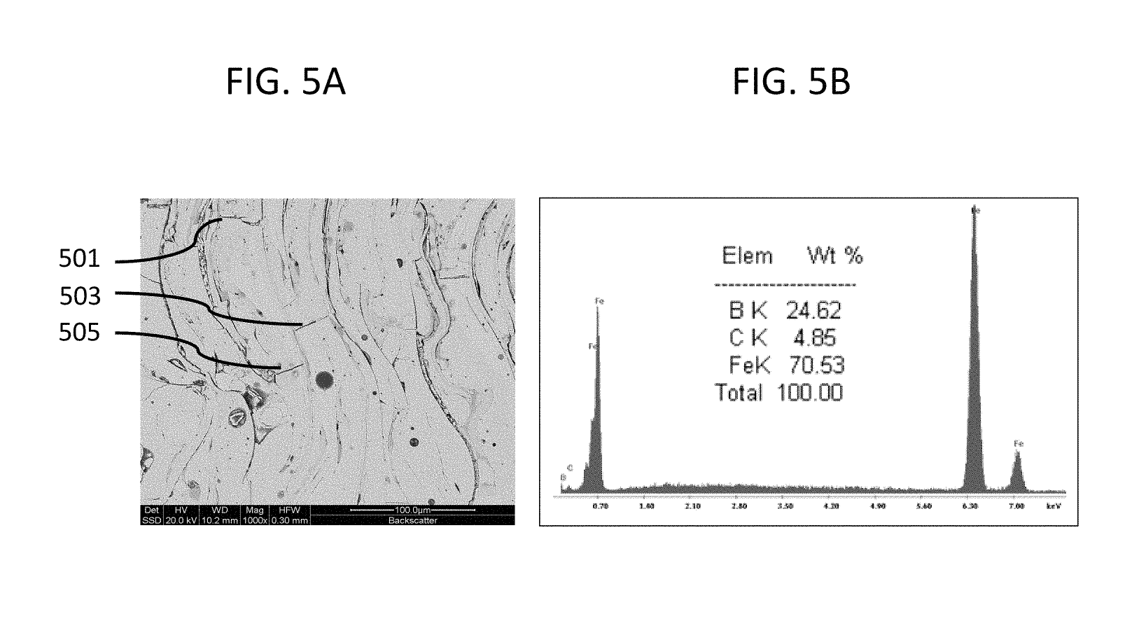

FIGS. 4A and 5A are images taken from a scanning electronic microscope of various cross-sectional cuts of the thermally sprayed substrates (steel block test samples) of the FAB and FB alloys after being coated onto the substrate. FIG. 4A shows a cross-sectional view of a layer of the FAB alloy, at a magnification of 1000×, while FIG. 5A shows a cross-sectional view of a layer of the FB alloy, at a magnification of 1000×. As illustrated by comparing FIGS. 4A and 5A, the FAB coating does not have any significant cracks, while the FB coating comprises multiple cracks 501, 503, 505 throughout the coating. These images show the positive effects of an exothermic reaction as part of the thermal spray process, such as by using the Al+Fe₂0₃ reaction. In particular, a thermal spray process that utilizes an exothermic reaction (e.g., the Al+Fe₂0₃ reaction created by including the aluminum and iron oxide materials in the cored wire) creates a coating on a substrate that has significantly less cracks (and is thus stronger and more resistant to wear and breaking) than conventionally sprayed coatings.

This comparison test between the FAB and FB alloys also demonstrates that the temperature achieved and the slower cooling rate allow for more diffusion conditions for carbon and boron. First, the comparison between FIGS. 4A (no cracks) and 5A (cracks) is indirect evidence of diffusion or the “gluing” of the droplets together during solidification. Second, FIGS. 4B and 5B show the corresponding elemental composition of the alloy breakdown from FIGS. 4A and 5A, respectively, at a magnification of approximately 300×. The Energy Dispersive Spectroscopy, or EDS, compositions shown in FIGS. 4B and 5B show the qualitative chemistries of the two alloys after being applied to the substrate. These elemental compositions further illustrate the different affects the described exothermic reaction creates on the substrate coating. For example, the FAB alloy (FIG. 4B) has a boron weight percentage of approximately 30.8% and a carbon weight percentage of approximately 5.9%; in contrast, the FB alloy (FIG. 5B) has a boron weight percentage of approximately 24.6% and a carbon weight percentage of approximately 4.8%. While the amount of boron and carbon are the same in both alloys, the FAB alloy coating has significantly more boron and carbon than the FB alloy coating. Thus, the exothermic reaction described herein enhances the diffusion of boron and carbon through the substrate coating. In particular, because diffusion rates are a function of time and temperature (with generally a higher temperature and/or a longer holding time creating greater diffusion), the greater temperature at a longer duration provided by the exothermic reaction from the FAB alloy creates enhanced boron and carbon transfer, diffusion, and bonding. This is a highly advantageous result, as it is generally known in the art that boron and carbon create a stronger coating, but conventional thermal spray techniques have not been successful in significantly enhancing boron and carbon diffusion.

### Example 2

As mentioned above, various compositions can be utilized within a cored wire to produce an exothermic reaction in the resultant coating as applied via thermal spray techniques. Another set of tests (similar to the above described tests) was performed on steel test blocks using a different wire composition. In this additional alloy embodiment, the utilized cored wire composition included powdered elements of lithium in addition to aluminum and iron oxide, along with boron and carbon. This coating is referred to as FABLi, as it uses a lithium reactive element. In contrast, the tests in Example 1 only utilized aluminum and iron oxide as the reactive elements to create the exothermic reaction Like the FAB alloy from Example 1, the inner core is approximately 30 weight percent of the wire and the outer sheath (steel) is approximately 70 weight percent of the wire. This coating was applied to a steel test sample via conventional thermal spray techniques as described above. As detailed below, this second wire composition (using lithium) is an additional embodiment and/or example of an exothermic reaction to produce the desired benefits as described herein.

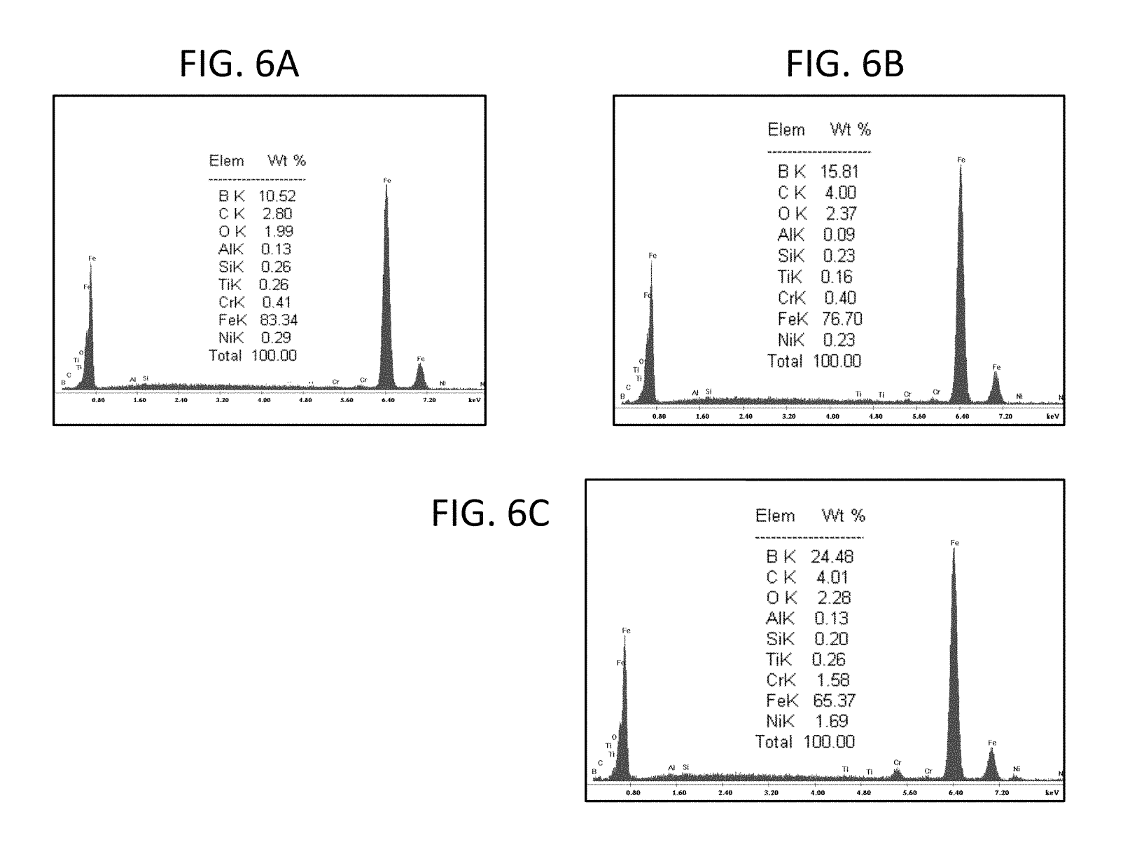

FIGS. 6A-6C illustrate various elemental compositions of the FABLi alloy in relation to the coating of a substrate. FIG. 6A shows the composition in a base material after being thermally sprayed with the FABLi alloy, FIG. 6B shows the composition at the interface between the base material and the FABLi alloy coating, and FIG. 6C shows the composition of the FABLi alloy coating after being thermally sprayed on the base material. The compositions illustrated in these figures, similar to FIGS. 4B and 5B, show the increased diffusion of boron and carbon as a result of the exothermic reaction. For example, FIG. 6C shows that the coating has an approximate weight percentage of 24.5% boron and 4.0% carbon, FIG. 6B shows that the interface has approximately 15.8% boron and 4.0% carbon, FIG. 6A shows that the base material has approximately 10.5% boron and 2.8% carbon. Thus, increased boron and carbon diffusion (as measured by SEM) is not solely a result of the aluminum and iron oxide reaction in Example 1, but is a result of any exothermic reaction that creates sufficient enough heat. It is noted that lithium is not indicated in these elemental composition breakdowns because SEM does not have the capability to measure and/or test for lithium.

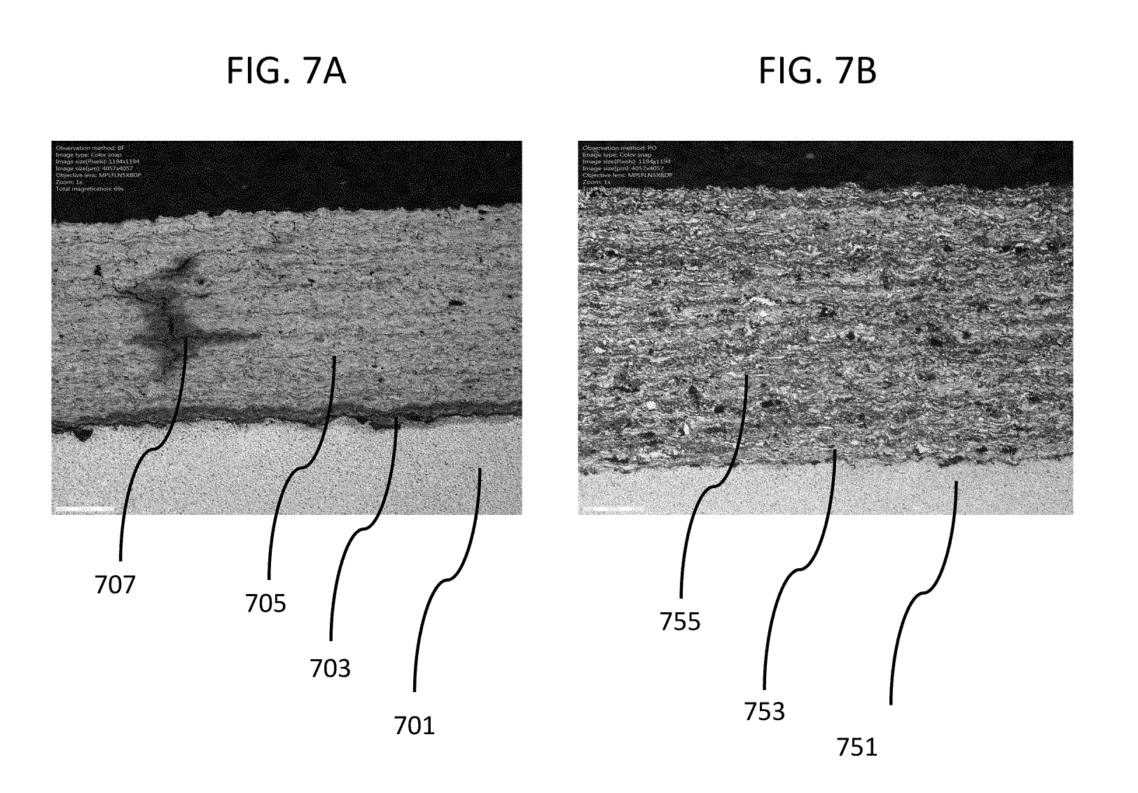

FIGS. 7A and 7B illustrate another visual test comparing a conventional alloy with an alloy of the present disclosure that utilizes an exothermic reaction. FIG. 7A illustrates a cross-sectional view of a thermal spray coating of a conventional alloy (i.e., an alloy that does not utilize an exothermic reaction) on a steel block test sample, at a magnification of approximately 69×. FIG. 7A illustrates base material 701, interface 703, thermal spray coating 705, and cracks 707 within thermal spray coating 705. FIG. 7B illustrates a cross-sectional view of a thermal spray coating of an alloy that utilizes an exothermic reaction according to one embodiment of the present disclosure, on a steel lock test sample at a magnification of approximately 69×. This alloy is the FABLi alloy, which utilizes aluminum and iron oxide and lithium. FIG. 7B illustrates base material 751 (which is the same base material as shown in FIG. 7A), interface 753, and thermal spray coating 755. As easily seen, there are no cracks present in coating 755. Thus, similar to comparing FIGS. 4A and 5A, comparing FIGS. 7A and 7B shows that an exothermic reaction produces a layer and/or coating that forms substantially no cracks.

In one embodiment, the use of an exothermic reaction as disclosed herein results in metallurgical bonding between the thermally sprayed droplet and the base material, which is very unusual in conventional thermal sprays. In typical thermal spray applications, a layer of metallic material is thermally sprayed onto a substrate such that the coating does not metallurgically affect the base material. For example, U.S. Pat. No. 7,487,840 discloses a wear-resistant layer that is sprayed onto a downhole component independent of metallurgical changes to a base material of the downhole component. Likewise, U.S. Pat. No. 9,920,412 discloses a coating that that does not substantially alter the metallurgical properties of the substrate. In contrast, for at least some exothermic reactions as described herein, metallurgical bonding occurs at the interface between the base material and the coating. In general, metallurgical bonding is chemical bonding, which is contrasted to mechanical bonding that is typical for thermally sprayed allows; this comparison might be likened to a bolted connection versus a welded connection. Metallurgical bonding is the result of chemical bonding that occurs between a substrate and coating areas that are in close contact or diffused evenly. Metallurgical bonding is essentially non-existent in thermal spray deposits as normal thermal spray deposits are mechanically interlocked into the roughened or profiled surface on the substrate and subsequent droplets follow this profile as they land on the surface. These mechanical bonds are not nearly as strong as a true metallurgical bond.

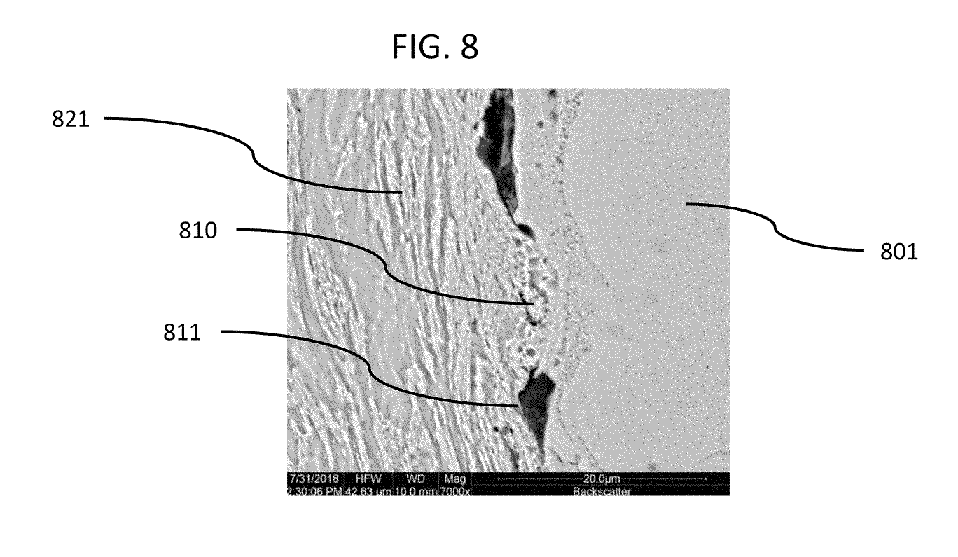

FIG. 8 shows such an example of metallurgical bonding of a thermal spray coating to a substrate using the disclosed exothermic reaction. In particular, FIG. 8 illustrates a cross-sectional view of a thermal spray coating on a steel test sample using an exothermic reaction according to one embodiment of the present disclosure, at a magnification of approximately 7000×. The composition is the same FABLi alloy as described above. The substrate is A36 steel test block. FIG. 8 illustrates base material 801 (steel), interface 811, and thermal spray coating 821. As easily seen, there is metallurgical bonding 810 at interface 811. As explained above, this metallurgical bonding is unexpected and not present in conventional thermally sprayed alloys and techniques. Metallurgical bonding is well known to be much superior in strength and ductility to merely mechanical bonds, and is thus desirable in many situations.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the system are within the scope of the invention. For example, the cored wire may or may not include aluminum (Al) and/or iron oxide (Fe₂O₃), as other components/reactants that create an exothermic reaction may be utilized, such as lithium or copper oxide. Similarly, a cored wire may or may not be used as part of the thermal spray technique, and the outer sheath of the cored wire may or may not be solid. Boron and/or carbon may or may not be used within the cored wire. The tool to be coated may be a downhole component or other tool used in the oil and gas industry, or may be applied to any object or tool that needs an increased wear and/or crack and/or corrosion resistant layer, such as in the aviation and marine industries, as well as dredge pups, cable sheaves, and helicopter landing runners, among others. The substrate may be metallic or non-metallic, such as fiberglass. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A composition for thermally spraying to a substrate, the composition comprising:
a plurality of reactants that create an exothermic reaction when ignited and thermally sprayed onto the substrate.

2. The composition of claim 1, wherein the plurality of reactants comprises powdered elements within a cored wire.

3. The composition of claim 1, wherein the plurality of reactants comprises aluminum and iron oxide.

4. The composition of claim 3, wherein the amount of aluminum to iron oxide is approximately 1 part aluminum to 3 parts iron oxide.

5. The composition of claim 3, wherein the amount of aluminum and iron oxide to other materials within the composition is at least 5 to 1.

6. The composition of claim 1, wherein the plurality of reactants comprises lithium and iron oxide.

7. The composition of claim 1, wherein the plurality of reactants comprises magnesium and copper oxide.

8. The composition of claim 1, wherein the plurality of reactants comprises an oxide and a metal.

9. The composition of claim 1, wherein the plurality of reactants comprises
an oxide selected from the group of an oxide of copper, nickel, chromium, boron, silicon, bismuth, manganese, iron, and lead; and
an active element selected from the group of aluminum, magnesium, lithium, titanium, zinc, and silicon.

10. The composition of claim 1, further comprising boron and carbon.

11. The composition of claim 1, wherein the exothermic reaction is effective to increase diffusion of boron within the substrate.

12. The composition of claim 1, wherein the exothermic reaction is effective to increase diffusion of carbon within the substrate.

13. The composition of claim 1, wherein the exothermic reaction is effective to cause metallurgical bonding between a layer of sprayed metallic material and the substrate.

14. The composition of claim 1, wherein the exothermic reaction is effective to reduce the amount of micro-cracks within a layer of sprayed metallic material on the substrate.

15. The composition of claim 1, wherein the exothermic reaction occurs in droplets of metallic material as they are sprayed onto the substrate.

16. The composition of claim 1, wherein the exothermic reaction occurs in droplets of metallic material during travel to the substrate.

17. The composition of claim 1, wherein the exothermic reaction occurs in droplets of metallic material after being coated on the substrate.

18. The composition of claim 1, wherein the exothermic reaction superheats droplets of metallic material during the thermal spray process.

19. A cored wire for thermally spraying to a substrate, the cored wire comprising:
an outer sheath substantially enclosing a plurality of powdered elements, wherein the plurality of powdered elements comprises a plurality of reactants that create an exothermic reaction when thermally sprayed onto the substrate.

20. The cored wire of claim 19, wherein the plurality of reactants comprises
an oxide selected from the group of an oxide of copper, nickel, chromium, boron, silicon, bismuth, manganese, iron, and lead; and
an active element selected from the group of aluminum, magnesium, lithium, titanium, zinc, and silicon.

21. The cored wire of claim 19, wherein a particle size for the plurality of reactants is approximately 30 microns or greater.

22. The cored wire of claim 19, wherein the outer sheath is substantially steel.

23. The cored wire of claim 19, wherein the outer sheath is substantially solid.

24. A thermally sprayed coating on a substrate, comprising:
a coating of metallic material on a substrate,
wherein the coating is formed by a plurality of reactants that create an exothermic reaction when ignited and thermally sprayed onto the substrate.

25. The coating of claim 24, wherein the plurality of reactants comprises powdered elements within a cored wire.

26. The coating of claim 24, wherein the substrate comprises boron and carbon diffused from the coating.

27. The coating of claim 24, wherein the substrate is metallic.

28. The coating of claim 24, wherein the substrate is non-metallic.

29. The coating of claim 24, wherein the coating comprises a wear-resistant layer.

30. The coating of claim 24, wherein the coating is substantially free of micro-cracks.

31. The coating of claim 24, wherein the substrate comprises a first coating with a first composition and a second coating with a second composition, wherein the second coating is formed by the exothermic reaction.

32. A method for applying a coating to a substrate, comprising:
thermally spraying metallic material on an external surface of a substrate; and
creating an exothermic reaction in the sprayed metallic material.

33. The method of claim 32, further comprising igniting a plurality of reactants within a cored wire to create the exothermic reaction.

34. The method of claim 32, wherein the plurality of reactants comprises an oxidizer and a fuel.

35. The method of claim 32, further comprising metallurgically bonding the sprayed metallic material with the substrate.

36. The method of claim 32, further comprising increasing a temperature of the metallic material on the substrate based on the exothermic reaction.

37. The method of claim 32, further comprising decreasing the cool down rate of the metallic material on the substrate based on the exothermic reaction.

38. The method of claim 32, further comprising diffusing boron into the substrate.

39. The method of claim 32, further comprising diffusing carbon into the substrate.

40. The method of claim 32, further comprising reducing the amount of micro-cracks within a layer of the sprayed metallic material on the substrate based on the exothermic reaction.

41. The method of claim 32, further comprising increasing the amount of boron or carbon diffusion into the substrate based on the exothermic reaction.

42. The method of claim 32, wherein the thermal spray technique comprises a twin wire arc spray.

43. The method of claim 32, wherein the substrate comprises a prior thermally sprayed coating, further comprising thermally spraying the metallic material on the prior coating.

44. A modified downhole component, comprising:
a downhole component with an external surface;
a layer of metallic material that is thermally sprayed onto a portion of the external surface;
wherein the layer is formed by a plurality of reactants that create an exothermic reaction when ignited and thermally sprayed onto the downhole component.

45. The component of claim 44, wherein the exothermic reaction is created by an ignition of a plurality of reactants within a cored wire.

46. The component of claim 44, wherein the layer is resistant to the formation of micro-cracks when used downhole.

47. The component of claim 44, wherein the component is a drill pipe.

48. The component of claim 44, wherein the component is a drill pipe tool joint.
